(19) United States
(12) Patent Application Publication
(10) Pub. No.: US 2022/0283637 A1
(43) Pub. Date: Sep. 8, 2022

(54) ELECTRONIC APPARATUS, METHOD FOR CONTROLLING THE SAME, AND RECORDING MEDIUM

(71) Applicant: CANON KABUSHIKI KAISHA, Tokyo (JP)

(72) Inventors: Kazuhiro Watanabe, Tokyo (JP); Shingo Yamazaki, Tokyo (JP); Takeshi Kikkawa, Kanagawa (JP); Mayu ONO, Tokyo (JP); Takeshi Nakata, Kanagawa (JP)

(21) Appl. No.: 17/686,067

(22) Filed: Mar. 3, 2022

(30) Foreign Application Priority Data
Mar. 8, 2021 (JP) 2021-036294

(51) Int. Cl. G06F 3/01; H04N 5/225; H04N 5/232

(52) U.S. Cl. CPC G06F 3/013; H04N 5/2257; H04N 5/23216

(57) ABSTRACT

An electronic apparatus includes an operation member configured to receive an operation performed by a user, a display device configured to display a display item, an eye tracking unit configured to detect a gaze point of the user on the display device, and an execution unit configured to perform control to execute a first processing corresponding to a first operation item assigned to the operation member or a second processing corresponding to a second operation item assigned to the display item displayed at the detected gaze point, in response to an operation to the operation member performed by a user. In a case where the display item is not displayed at the detected gaze point, the execution unit performs control to execute the first processing, and in a case where the display item is displayed at the detected gaze point, the execution unit performs control to execute the second processing.

### BACKGROUND

### Field of the Disclosure

The present disclosure relates to an electronic apparatus capable of receiving an operation based on user's eye tracking, a method for controlling the electronic apparatus, and a recording medium.

### Description of the Related Art

Conventionally, electronic apparatuses, such as a digital camera, have various operation members including a dial and a button. When a user looks into a finder of the digital camera, these operation members are out of sight of the user, and thus the user has difficulty in correctly selecting an operation member to perform an intended operation. With an electric apparatus having a configuration for detecting a user's gaze and determining an operation item for an operation based on a gaze point of the user's gaze, the user can perform the operation while keeping looking into the finder.

For example, Japanese Patent Application Laid-Open No. 2009-251658 discusses a configuration in which a gaze of a user observing a screen is detected, and after selection of a menu item corresponding to a gaze point of the detected gaze, the selected menu item is confirmed in response to detection of a blink of the user's eye.

### SUMMARY

According to an aspect of the present invention, an electronic apparatus includes an operation member configured to receive an operation performed by a user, a display device configured to display a display item, and at least one memory and at least one processor which function as an eye tracking unit configured to detect a gaze point of the user on the display device, and an execution unit configured to perform control to execute a first processing corresponding to a first operation item assigned to the operation member or a second processing corresponding to a second operation item assigned to the display item displayed at the detected gaze point, in response to an operation to the operation member performed by a user, wherein, in a case where the display item is not displayed at the detected gaze point, the execution unit performs control to execute the first processing, and in a case where the display item is displayed at the detected gaze point, the execution unit performs control to execute the second processing.

Further features of the present invention will become apparent from the following description of exemplary embodiments with reference to the attached drawings.

### BRIEF DESCRIPTION OF THE DRAWINGS

FIGS. 1A and 1B are diagrams illustrating an external configuration of an electronic apparatus.

FIG. 2 is a block diagram illustrating an example of an internal configuration of the electronic apparatus.

FIG. 3 is a flowchart illustrating an example of processing for changing a target operation item according to an operation onto an operation member.

FIGS. 4A and 4B are diagrams each illustrating a display example of a setting item screen.

FIGS. 5A to 5E are diagrams each illustrating a screen display on an electric view finder (EVF).

FIGS. 6A to 6C are diagrams illustrating an external appearance of an electronic apparatus according to a second exemplary embodiment. FIG. 6D is a diagram illustrating an internal configuration of the electronic apparatus according to the second exemplary embodiment.

FIGS. 7A and 7B are flowcharts illustrating an example of Internet-of-Things (IoT) control processing in response to an operation on an operation member.

FIGS. 8A to 8C are screen transition diagrams illustrating a transition of a screen that is displayed on a display unit of the electronic apparatus according to the second exemplary embodiment.

### DESCRIPTION OF THE EMBODIMENTS

In the following description, representative exemplary embodiments of the present invention will be described in detail with reference to the drawings. Similar components will be identified by the same reference numerals in principle in each of the drawings, and redundant descriptions thereof will be omitted. Numerical values and the like that will be exemplified to provide a specific description are not intended to limit the present invention thereto unless otherwise specifically indicated.

The present invention is not limited to the exemplary embodiments that will be described below, and can be modified as appropriate within a range that does not depart from the spirit thereof. For example, the respective configurations of the exemplary embodiments that will be described below may be corrected or changed as appropriate according to the configuration of an apparatus to which the present invention is applied and/or various kinds of conditions.

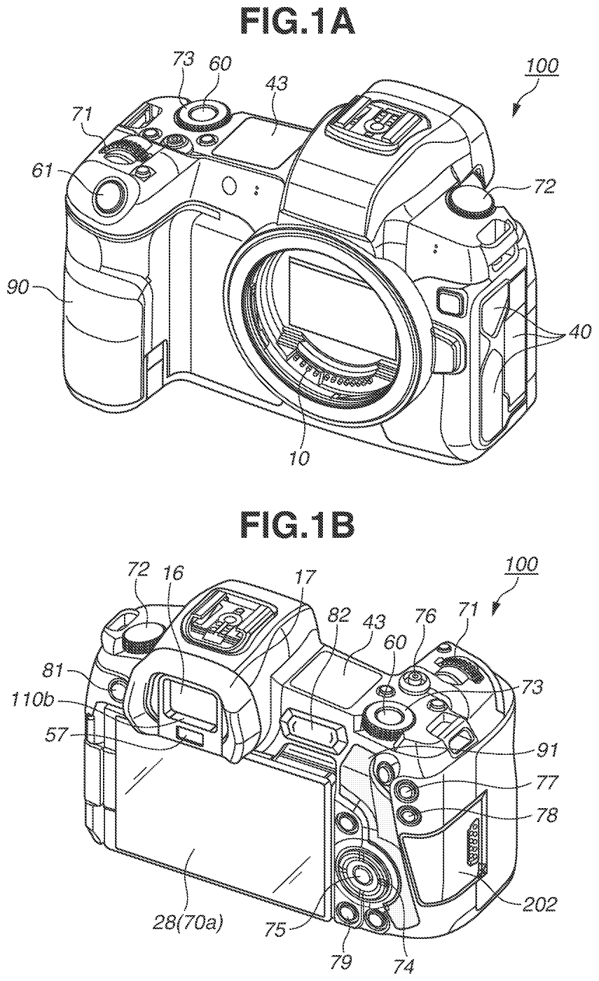

FIGS. 1A and 1B are diagrams illustrating an exterior appearance of a digital camera 100 as an example of an electronic apparatus to which a first exemplary embodiment can be applied. FIG. 1A is a perspective view of a front side of the digital camera 100, and FIG. 1B is a perspective view of a back side of the digital camera 100.

A display unit 28 is a display unit provided on the back side of the digital camera 100, and displays an image and various kinds of information. A touch panel 70a can detect a touch operation performed on a display surface (a touch operation surface) of the display unit 28. An external finder display unit 43 is a display unit provided on a top surface of the digital camera 100, and displays various setting values of the digital camera 100 including a shutter speed and an aperture. A shutter button 61 is an operation member for issuing an imaging instruction. A mode selection switch 60 is an operation member for switching various kinds of modes.

A terminal cover 40 is a cover protecting a connector (not illustrated) for a connection cable or the like that connects the digital camera 100 to an external apparatus.

A main electronic dial 71 is a rotational operation member and is used to change, for example, setting values, such as the shutter speed and the aperture, by rotating the main electronic dial 71. A power switch 72 is an operation member for switching a power-on/off of the digital camera 100. A sub electronic dial 73 is a rotational operation member and is used to move, for example, a selection frame and display subsequent images by rotating the sub electronic dial 73. A four direction key pad 74 is configured in such a manner that an upper portion, a lower portion, a left portion, and a right portion of the four direction key pad 74 can be individually pressed, and is used to perform processing based on a pressed portion of the four direction key pad 74. A SET button 75 is a push button and is mainly used to determine a selected item, for example.

A moving image button 76 is used to instruct the digital camera 100 to start or stop capturing (recording) a moving image. An automatic exposure (AE) lock button 77 is a push button, and an exposure state can be fixed by pressing the AE lock button 77 in an imaging standby state. An enlargement button 78 is an operation button for switching on and off an enlargement mode on a live view display (an LV display) in an imaging mode. A live view image (an LV image) can be enlarged and reduced by operating the main electronic dial 71 after switching on the enlargement mode. The enlargement button 78 functions as an operation button for enlarging a playback image or increasing an enlargement ratio of a playback image in a playback mode. A playback button 79 is an operation button for switching the imaging mode and the playback mode. Pressing the playback button 79 during the imaging mode causes the digital camera 100 to transition to the playback mode, and the latest image among images recorded in a recording medium 200 (which will be described below) is displayed on the display unit 28. A menu button 81 is a push button and is used to perform an instruction operation for displaying a menu screen, and the menu screen where various kinds of settings can be performed is displayed on the display unit 28, in response to the menu button 81 being pressed. A user can intuitively perform the various kinds of settings by using the menu screen displayed on the display unit 28, the four direction key pad 74, and the SET button 75.

A touch bar 82 (a multifunction bar or an M-Fn bar) is a linear touch operation member (a line touch sensor) capable of receiving a touch operation. The touch bar 82 is disposed at a position where the user can perform a touch operation (can touch the touch bar 82) with the thumb of the right hand holding a grip portion 90 when the user holds the digital camera 100 in a normal manner (in a manner recommended by the manufacturer). The touch bar 82 is a reception unit capable of receiving a tap operation (an operation of touching the touch bar 82 and then releasing the touch without moving the touch position within a predetermined period), a leftward or rightward slide operation (an operation of touching the touch bar 82 and moving the touch position while keeping the touch after that), and the like on the touch bar 82. The touch bar 82 is an operation member different from the touch panel 70a, and is not equipped with a display function.

A communication terminal 10 is a terminal for use in communication of the digital camera 100 with a lens unit 150 (detachably attachable lens) (described below). An eyepiece unit 16 is provided to an eyepiece finder 17 (a finder designed to be looked into), and the user can visually check a video image displayed on an internal electric view finder (EVF) 29 via the eyepiece unit 16. An eye proximity detection unit 57 is an eye proximity detection sensor that detects whether the user (a camera operator) brings his/her eye in proximity to the eyepiece unit 16.

Eye tracking units 110a (not illustrated) and 110b, collectively called as an eye tracking unit 110, are disposed above and below the eyepiece finder 17, respectively. When the user looks into the eyepiece finder 17, the user's gaze is detected by the eye tracking units 110a and 110b to determine where the user is viewing on the EVF 29.

A cover 202 is a cover of a slot in which the recording medium 200 (described below) is housed. The grip portion 90 is a holding portion having such a shape that can be easily gripped by the user's right hand when the user holds the digital camera 100. The shutter button 61 and the main electronic dial 71 are disposed at positions where the user can operate them with the index finger of his/her right hand in a state of holding the digital camera 100 while gripping the grip portion 90 with the little finger, the ring finger, and the middle finger of his/her right hand. The sub electronic dial 73 and the touch bar 82 are disposed at positions where the user can operate them with the thumb of his/her right hand in the same state. A thumb rest portion 91 (a thumb standby position) is a grip member disposed at a position on the back side of the digital camera 100 where the user can easily rest the thumb of his/her right hand holding the grip portion 90 in a state of not operating any operation member. The thumb rest portion 91 is made of, for example, a rubber member for enhancing the holding force (a gripping feeling).

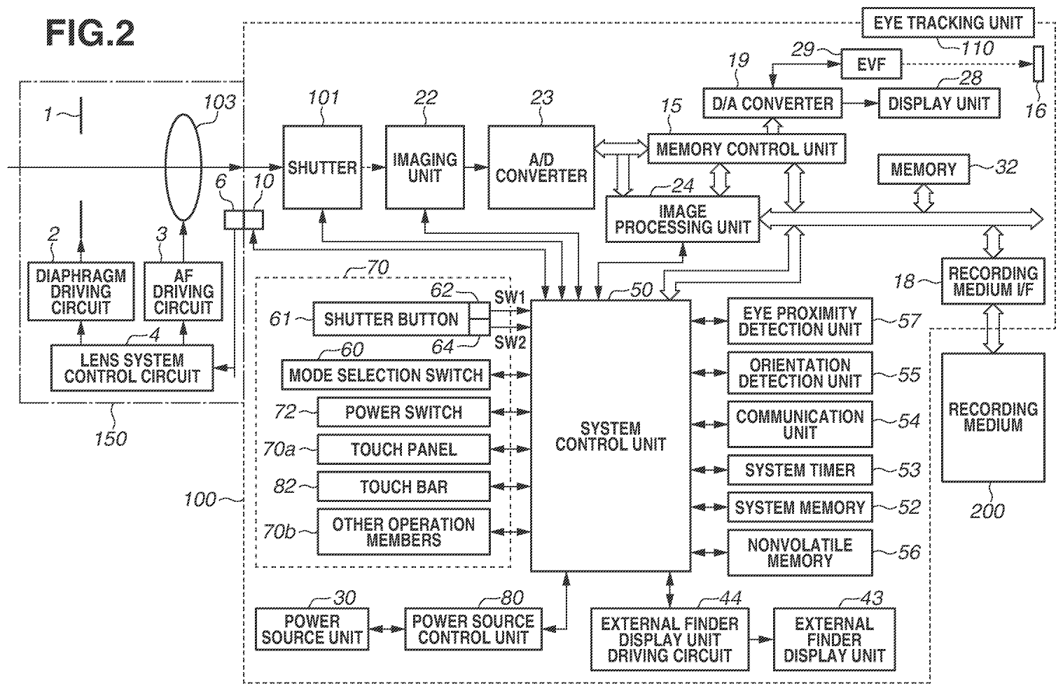

FIG. 2 is a block diagram illustrating the configuration of the digital camera 100. The lens unit 150 is a unit on which an interchangeable imaging lens is mounted. A lens 103 is normally includes a plurality of lenses, but is illustrated as one lens in FIG. 2 for the purpose of simplification. A communication terminal 6 is a terminal for use in communication of the lens unit 150 with the digital camera 100, and the communication terminal 10 is the communication terminal for use in communication of the digital camera 100 with the lens unit 150. The lens unit 150 communicates with a system control unit 50 via the communication terminals 6 and 10. The lens unit 150 includes a lens system control circuit 4 and controls a diaphragm 1 by the lens system control circuit 4 via a diaphragm driving circuit 2. Further, the lens unit 150 displaces the position of the lens 103 by the lens system control circuit 4 via an automatic focus (AF) driving circuit 3 to adjust the focus of the lens unit 150.

A shutter 101 is a focal plane shutter capable of freely controlling an exposure time of an imaging unit 22 under control of the system control unit 50.

The imaging unit 22 is an image sensor, such as a charge-coupled device (CCD) element or a complementary metal-oxide semiconductor (CMOS) element, for converting an optical image into an electric signal. The imaging unit 22 may include an image plane phase-difference sensor that outputs defocus amount information to the system control unit 50. An analog-to-digital (A/D) converter 23 converts an analog signal output from the imaging unit 22 into a digital signal.

An image processing unit 24 performs predetermined processing (pixel interpolation, resizing processing including size reduction and the like, color conversion processing, and the like) on data output from the A/D converter 23 or data output from a memory control unit 15. Further, the image processing unit 24 performs predetermined calculation processing using captured image data, and the system control unit 50 controls an exposure and ranging, based on a calculation result acquired by the image processing unit 24. Based on this control, the digital camera 100 performs, for example, automatic focus (AF) processing, automatic exposure (AE) processing, and electro focus (EF) (flash preliminary emission) processing of the Through-The-Lens (TTL) method. The image processing unit 24 further performs predetermined calculation processing using captured image data, and performs automatic white balance (AWB) processing of the TTL method, based on an acquired calculation result.

Output data from the A/D converter 23 is written into a memory 32 via the image processing unit 24 and the memory control unit 15. Alternatively, the output data from the A/D converter 23 is written into the memory 32 via the memory control unit 15 without an intervention of the image processing unit 24. The memory 32 stores therein image data that is acquired by the imaging unit 22 and converted into digital data by the A/D converter 23, and image data to be displayed on the display unit 28 or the EVF 29. The memory 32 has a storage capacity sufficient to store a predetermined number of still images or moving images and audio data lasting for a predetermined time.

Further, the memory 32 also serves as a memory for an image display (a video memory). A digital-to-analog (D/A) converter 19 converts data for image display that is stored in the memory 32 into an analog signal, and supplies the converted data to the display unit 28 or the EVF 29. In this manner, the image data for the display in the memory 32 is displayed by the display unit 28 or the EVF 29 via the D/A converter 19. Each of the display unit 28 and the EVF 29 performs a display according to an analog signal from the D/A converter 19 on a display device, such as a liquid crystal display (LCD) and an organic electro luminescence (EL) display. The live view display (the LV) can be performed in such a manner that the D/A converter 19 converts digital signal that has been subjected to the A/D conversion by the A/D converter 23 and accumulated in the memory 32, into an analog signal and sequentially transfers and displays the transferred signal onto the display unit 28 or the EVF 29.

Hereinafter, the image that is displayed in live view display will be referred to as a live view image (an LV image).

Various setting values of the digital camera 100 including the shutter speed and the aperture are displayed on the external finder display unit 43 via an external finder display unit driving circuit 44.

A nonvolatile memory 56 is an electrically erasable and recordable memory, and is, for example, an electrically erasable programmable read only memory (EEPROM). The nonvolatile memory 56 stores therein a constant for operation of the system control unit 50, a program, and the like. The program described here refers to a program for performing various kinds of processing procedures that will be described below with flowcharts in the present exemplary embodiment.

The system control unit 50 is a control unit including at least one processor or circuit, and generally controls the digital camera 100. The system control unit 50 realizes each processing procedure in the present exemplary embodiment that will be described below by executing the program recorded in the nonvolatile memory 56. A system memory 52 is, for example, a random access memory (RAM), and the system control unit 50 develops the constant and the variable for the operation of the system control unit 50, the program read out from the nonvolatile memory 56, and the like into the system memory 52. Further, the system control unit 50 also performs display control by controlling the memory 32, the D/A converter 19, the display unit 28, and the like.

A system timer 53 is a time measurement unit that measures a time for use in various kinds of control, and the time of a built-in clock.

A power source control unit 80 includes a battery detection circuit, a direct-current-to-direct-current (DC-DC) converter, a switch circuit that switches a block to which power is supplied, and the like, and, for example, detects whether a battery is mounted, a type of the battery, and the remaining battery level. Further, the power source control unit 80 controls the DC-DC converter based on a result of the detection and an instruction from the system control unit 50, and supplies a required voltage to each of the units including the recording medium 200 for a required period. A power source unit 30 includes a primary battery, such as an alkaline battery and a lithium battery, and a secondary battery, such as a nickel-cadmium (NiCd) battery, a nickel metal hydride (NiMH) battery, a lithium (Li) battery, an alternating-current (AC) adapter, or the like.

A recording medium interface (I/F) 18 is an interface with the recording medium 200, such as a memory card and a hard disk. The recording medium 200 is a recording medium, such as a memory card, for recording a captured image and includes a semiconductor memory, a magnetic disk, or the like.

A communication unit 54 transmits and receives a video signal and an audio signal between the digital camera 100 and an external apparatus connected wirelessly or via a wired cable. The communication unit 54 can also be connected to a wireless local area network (LAN) or the Internet. Further or alternatively, the communication unit 54 can also communicate with an external apparatus using Bluetooth® or Bluetooth® Low Energy. The communication unit 54 can transmit an image captured by the imaging unit 22 (including a LV image) and an image recorded in the recording medium 200, and can receive image data and other various kinds of information from the external apparatus.

An orientation detection unit 55 detects an orientation of the digital camera 100 with respect to the direction of gravitational force. It can be determined whether an image captured by the imaging unit 22 is captured with the digital camera 100 held in a landscape orientation or an image captured with the digital camera 100 held in a portrait orientation, based on the orientation detected by the orientation detection unit 55. The system control unit 50 can add orientation information according to the orientation detected by the orientation detection unit 55 to an image file of the image captured by the imaging unit 22 and record an image after rotating the image, for example. An acceleration sensor, a gyroscope sensor, or the like can be used as the orientation detection unit 55. A motion of the digital camera 100 (for example, whether the digital camera 100 is panned, tilted, lifted up, or stationary) can also be detected using the acceleration sensor or the gyroscope sensor serving as the orientation detection unit 55.

An eye proximity detection unit 57 is an eye proximity detection sensor that detects an approach (eye proximity) and a separation (eye separation) of the eye (an object) to and from the eyepiece unit 16 of the eyepiece finder 17 (hereinafter will be simply referred to as a “finder”) (approach detection). The system control unit 50 switches display (a display state)/non-display (a non-display state) on the display unit 28 and the EVF 29 according to the state detected by the eye proximity detection unit 57. More specifically, in a case where the digital camera 100 is at least in the imaging standby state and an automatic switching for a display destination is set, the display destination is switched to the display unit 28 and the display on the display unit 28 is turned on, and the EVF 29 is set to the non-display, while the eye proximity is not detected. On the other hand, the display destination is switched to the EVF 29 and the display on the EVF 29 is turned on, and the display unit 28 is set to the non-display, while the eye proximity is detected. An infrared proximity sensor can be used as the eye proximity detection unit 57, and the eye proximity detection unit 57 can detect an approach of some object to the eyepiece unit 16 of the finder 17 including the EVF 29. In a case where an object approaches the eyepiece unit 16, an infrared ray projected from a light projection unit (not illustrated) of the eye proximity detection unit 57 is reflected on the object and is received by a light reception unit (not illustrated) of the infrared proximity sensor. The eye proximity detection unit 57 can even determine how close the object approaches the eyepiece unit 16 in terms of the remaining distance from the eyepiece unit 16 (an eye proximity distance), based on an amount of the received infrared ray. In this manner, the eye proximity detection unit 57 performs eye proximity detection for detecting a proximity distance of the object to the eyepiece unit 16. Accordingly, in a case where an object approaching the eyepiece unit 16 as far as within a predetermined distance from the eyepiece unit 16 is detected in a non-eye proximity state (a non-approach state), the eye proximity detection unit 57 detects that the eye is brought into proximity. In a case where an object that has been detected to approach the eyepiece unit 16 is separated by a predetermined distance or longer in an eye proximity state (an approach state), the eye proximity detection unit 57 detects that the eye is separated. A threshold value for detecting the eye proximity and a threshold value for detecting the eye separation may be set to different values by, for example, providing a hysteresis. Further, after the eye proximity is detected, the eye proximity state continues until the eye separation is detected. After the eye separation is detected, the non-eye proximity state continues until the eye proximity is detected. The infrared proximity sensor is an example, and a different sensor may be employed as the eye proximity detection unit 57 as long as the employed sensor can detect an approach of an eye or an object that can be determined as the eye proximity.

The eye tracking unit 110 is a gaze point detection sensor that determines which portion the user is viewing on the EVF 29.

An operation unit 70 is an input unit that receives an operation from the user (a user operation), and is used to input various kinds of operation instructions to the system control unit 50. As illustrated in FIG. 2, the operation unit 70 includes the mode selection switch 60, the shutter button 61, the power switch 72, the touch panel 70a, the touch bar 82, and the like. Further, the operation unit 70 includes the main electronic dial 71, the sub electronic dial 73, the four direction key pad 74, the SET button 75, the moving image button 76, the AE lock button 77, the enlargement button 78, the playback button 79, the menu button 81, and the like, as other operation members 70b.

The mode selection switch 60 switches the operation mode of the system control unit 50 to one of a still image capturing mode, a moving image capturing mode, the playback mode, and the like. Examples of modes included in the still image capturing mode are an automatic imaging mode, an automatic scene determination mode, a manual mode, an aperture priority mode (an aperture value (Av) mode), a shutter speed priority mode (a time value (Tv) mode), and a program AE mode (a P mode). Further, there are also various kinds of scene modes, each of which corresponds to a different one of imaging settings prepared for respective imaging scenes, a custom mode, and the like. The user can directly switch the operation mode to one of these modes using the mode selection switch 60. Alternatively, the user may operate the digital camera 100 to switch display of the digital camera 100 to a screen of a list of the imaging modes using the mode selection switch 60, and then, selectively switch the operation mode to one of the plurality of displayed modes using another operation member. Similarly to the still image capturing mode, the moving image capturing mode may also include a plurality of modes.

The shutter button 61 includes a first shutter switch 62 and a second shutter switch 64. The first shutter switch 62 is switched on and generates a first shutter switch signal SW1 halfway through an operation on the shutter button 61, i.e., upon so-called half-pressing of the shutter button 61 (an imaging preparation instruction). In response to the first shutter switch signal SW1, the system control unit 50 starts an imaging preparation operation, such as the AF processing, the AE processing, the AWB processing, and the EF processing. The second shutter switch 64 is switched on and generates a second shutter switch signal SW2 upon completion of an operation on the shutter button 61, i.e., upon so-called full-pressing of the shutter button 61 (an imaging instruction). In response to the second shutter switch signal SW2, the system control unit 50 starts a series of imaging processing operations from reading out signals from the imaging unit 22 to writing a captured image into the recording medium 200 as an image file.

The touch panel 70a and the display unit 28 can be configured integrally with each other. For example, the touch panel 70a is configured in such a manner that a light transmittance of the touch panel 70a does not disturb the display on the display unit 28, and is disposed on an upper layer of the display surface of the display unit 28. Then, an input coordinate on the touch panel 70a and a display coordinate on the display screen of the display unit 28 are associated with each other. This configuration can provide a graphical user interface (GUI) that appears as if the user can directly operate the screen displayed on the display unit 28. The GUI is an example of a predetermined display item in the present exemplary embodiment. The system control unit 50 can detect the following operations onto the touch panel 70a or states of the touch panel 70a.
A finger or a pen that has been out of touch with the touch panel 70a newly touches the touch panel 70a. In other words, a touch is started (hereinafter referred to as a Touch-Down).
The touch panel 70a is in a state of being touched by the finger or the pen (hereinafter referred to as a Touch-On).
The finger or the pen is being moved while keeping touching the touch panel 70a (hereinafter referred to as a Touch-Move).
The finger or the pen that has been in touch with the touch panel 70a is separated (released) from the touch panel 70a. In other words, the touch is ended (hereinafter referred to as a Touch-Up).
The touch panel 70a is in a state of being touched by nothing (hereinafter referred to as a Touch-Off).

In a case where a Touch-Down is detected, a Touch-On is also detected at the same time. After the Touch-Down, the detection of the Touch-On normally continues as long as a Touch-Up is not detected. In a case where a Touch-Move is detected, a Touch-On is also detected at the same time. Even when a Touch-On is detected, a Touch-Move is not detected unless the touched position is being moved. After detection of a Touch-Up of all of the finger(s) or the pen(s) that has/have been in touch with the touch panel 70a, the touch panel 70a transitions to a Touch-Off.

The system control unit 50 is notified of these operations/states and the positional coordinate touched by the finger or the pen on the touch panel 70a via an internal bus. Then, the system control unit 50 determines what kind of operation (touch operation) is performed on the touch panel 70a, based on the information that the system control unit 50 is notified of. Regarding a Touch-Move, the system control unit 50 can also determine a movement direction of the finger or the pen in motion on the touch panel 70a, based on a change in positional coordinates, for each of a vertical component and a horizontal component on the touch panel 70a. The system control unit 50 determines that a slide operation is performed in a case where the system control unit 50 detects that a Touch-Move is performed by a predetermined distance or longer. An operation of quickly moving the finger only by a certain distance while keeping the finger in touch on the touch panel 70a, and separating the finger from the touch panel 70a directly therefrom will be referred to as a flick. In other words, a flick is an operation of quickly running the finger on the touch panel 70a as if flicking the surface of the touch panel 70a with the finger.

The system control unit 50 can determine that a flick is performed in a case where the system control unit 50 detects that a Touch-Move is performed by a predetermined distance or longer at a predetermined speed or higher and detects a Touch-Up directly therefrom (can determine that a flick is performed subsequently to the slide operation). Further, a touch operation of touching a plurality of portions (for example, two points) together (inputting a multi-touch) and moving the respective touched positions toward each other will be referred to as a pinch-in, and a touch operation of moving the respective touched positions away from each other will be referred to as a pinch-out. A pinch-out and a pinch-in will be collectively referred to as a pinch operation (or simply a pinch). The touch panel 70a may employ any type of touch panel from among touch panels working based on various methods, such as a resistive film method, a capacitive method, a surface acoustic wave method, an infrared method, an electromagnetic induction method, an image recognition method, and an optical sensor method. Examples of touch detection types include detecting a touch based on the presence of a touch onto the touch panel 70a and detecting a touch based on the presence of an approach of the finger or the pen to the touch panel 70a. The touch panel 70a can employ any type of them.

The system control unit 50 can also detect the following operations onto the touch bar 82 or states of the touch bar 82.
A finger that has been out of touch with the touch bar 82 newly touches the touch bar 82. In other words, a touch is started (hereinafter referred to as a Touch-Down).
The touch bar 82 is in a state of being touched by the finger (hereinafter referred to as a Touch-On).
The finger is being moved while keeping touching the touch bar 82 (hereinafter referred to as a Touch-Move).
The finger that has been in touch with the touch bar 82 is separated (released) from the touch bar 82. In other words, the touch is ended (hereinafter referred to as a Touch-Up).
The touch bar 82 is in a state touched by nothing (hereinafter referred to as a Touch-Off).

In a case where a Touch-Down is detected, a Touch-On is also detected at the same time. After the Touch-Down, the detection of the Touch-On normally continues as long as a Touch-Up is not detected. In a case where a Touch-Move is detected, a Touch-On is also detected at the same time. Even in a case where a Touch-On is detected, a Touch-Move is not detected unless the touched position is being moved. After detection of a Touch-Up of all of the finger(s) that has/have been in touch with the touch bar 82, the state of the touch bar 82 is detected as a Touch-Off.

The system control unit 50 is notified of these operations/states and coordinates of a position touched by the finger on the touch bar 82 via an internal bus, and determines what kind of operation (touch operation) is performed on the touch bar 82 based on the information that the system control unit 50 is notified of. In a Touch-Move, the system control unit 50 detects a horizontal (leftward/rightward) movement on the touch bar 82. The system control unit 50 determines that a slide operation is performed in a case where the system control unit 50 detects that a touched position is moved by a predetermined distance or longer (the movement amount of the touch operation reaches a predetermined amount or more). The system control unit 50 determines that a tap operation is performed in a case where the system control unit 50 detects a touch on the surface of the touch bar 82 with the finger and releasing the touch within a predetermined time without performing a slide operation. The touch bar 82 is a capacitive-type touch sensor in the present exemplary embodiment. However, the touch bar 82 may be a touch sensor that works based on another method, such as a resistive film method, a surface acoustic wave method, an infrared method, an electromagnetic induction method, in image recognition method, and an optical sensor method.

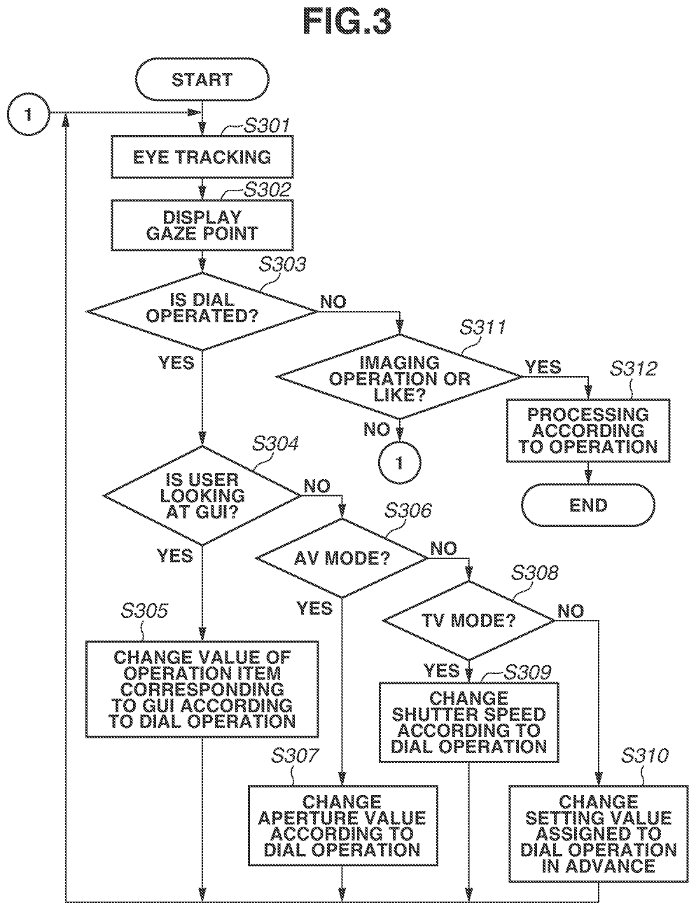

Next, a processing operation for changing a setting value based on an operation onto an operation member by the digital camera 100 according to the present exemplary embodiment will be described with reference to a flowchart illustrated in FIG. 3.

A processing procedure illustrated in FIG. 3 is started according to detection of a user's eye approach to the finder 17 by the eye proximity detection unit 57.

In step S301, the system control unit 50 detects a user's gaze point by the eye tracking unit 110. In step S302, the system control unit 50 displays a gaze point pointer 503 (which will be described below) at the user's gaze point on the EVF 29.

Then, in step S303, the system control unit 50 determines whether the main electronic dial 71 is rotated by the user. In a case where the system control unit 50 determines that the main electronic dial 71 is rotated (YES in step S303), the processing proceeds to step S304. In step S304, the system control unit 50 further determines whether a predetermined display item is displayed at the user's gaze point. In other words, the system control unit 50 determines whether the user is viewing the predetermined display item by directing his/her gaze to the item. In a case where the system control unit 50 determines that the predetermined display item is displayed at the gaze point (YES in step S304), the processing proceeds to step S305. In step S305, the system control unit 50 changes a value of an operation item corresponding to the predetermined display item (for example, a value of exposure correction in a case where the system control unit 50 determines that the user is viewing an exposure level indicator) according to the dial rotation.

On the other hand, in a case where the system control unit 50 determines that the predetermined display item is not displayed at the gaze point (NO in step S304), the processing proceeds to step S306. In steps S306 and S308, the system control unit 50 sequentially determines the imaging mode of the digital camera 100. More specifically, the system control unit 50 determines which imaging mode of the still image capturing mode is set from among the aperture priority mode (the Av) mode), the shutter speed priority mode (the Tv mode), and the like. More specifically, in step S306, the system control unit 50 determines whether the still image capturing mode is set to the aperture priority mode (the Av mode). In a case where the still image capturing mode is set to the aperture priority mode (the Av mode) (YES in step S306), the processing proceeds to step S307. In step S307, the system control unit 50 changes the aperture value according to the dial rotation. In a case where the determination in the step S306 is NO, the processing proceeds to step S308, and in step S308, the system control unit 50 determines whether the still image capturing mode is set to the shutter speed priority mode (the Tv mode). In a case where the still image capturing mode is set to the shutter speed priority mode (the Tv mode) (YES in step S308), the processing proceeds to step S309. In step S309, the system control unit 50 changes the shutter speed according to the dial rotation. In a case where the still image capturing mode is neither the Av mode nor the Tv mode (NO in steps S306 and S308), in step S310, the system control unit 50 changes a value of a function setting preassigned to the dial operation according to the dial rotation.

In a case where the system control unit 50 determines that the main electronic dial 71 is not rotated by the user in step S303 (NO in step S303), the processing proceeds to step S311. In step S311, the system control unit 50 further determines whether an operation, such as imaging, is performed by the user. Then, in a case where an operation is performed by the user (YES in step S311), the processing proceeds to step S312. In step S312, the system control unit 50 performs processing according to the performed operation. Then, the processing procedure is ended. On the other hand, in a case where the system control unit 50 determines that no operation is performed by the user (NO in step S311), the digital camera 100 returns to the state immediately after the start of the processing procedure of the flowchart.

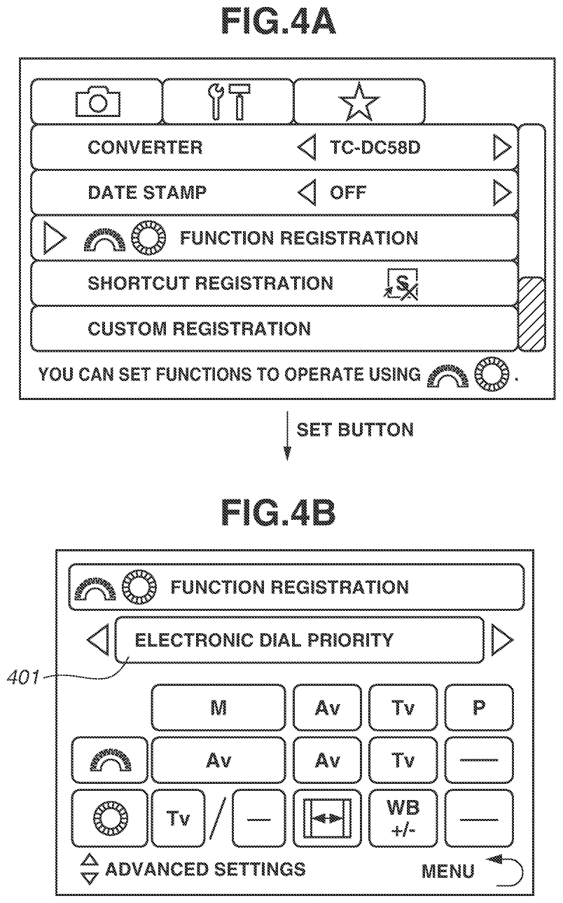

Next, an operation of assigning a function setting to the main electronic dial 71 by the user will be described with reference to screen transition diagrams illustrated in FIGS. 4A and 4B.

In a case where the menu button 81 included in the operation unit 70 is pressed in one of the still image capturing modes, a menu screen like the example illustrated in FIG. 4A is displayed on the display unit 28. In a case where a “function registration” item is selected on the menu screen and then the SET button 75 is pressed, a function registration screen on which the user can check how each function is assigned in a plurality of imaging modes all at once, like the example illustrated in FIG. 4B, is displayed on the display unit 28. In FIG. 4B, a preset switching bar 401 is a display field that is used to set which operation member is assigned as a priority operation member. Selection of operation member to be assigned as the priority operation member can be performed by pressing a left or right button with a selection frame placed on the preset switching bar 401.

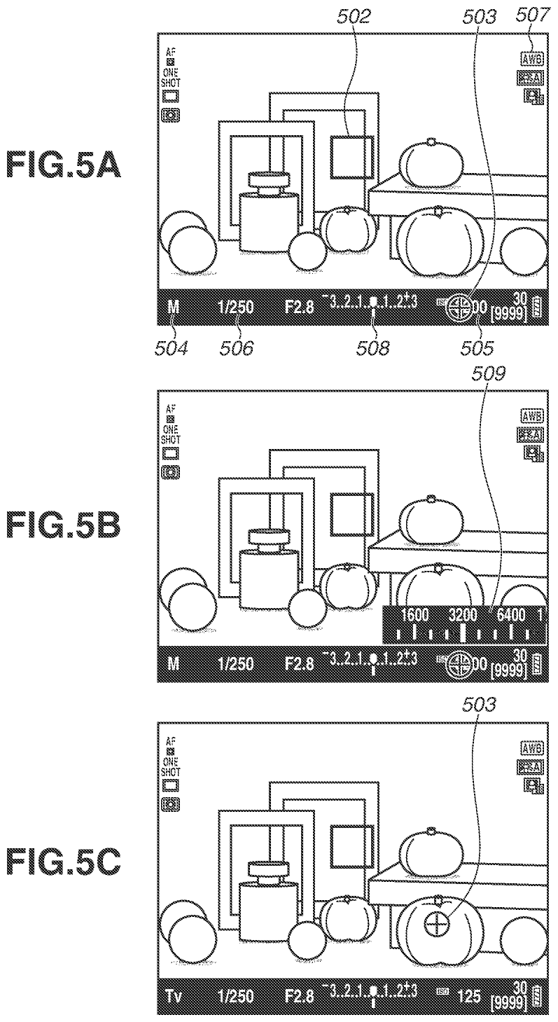

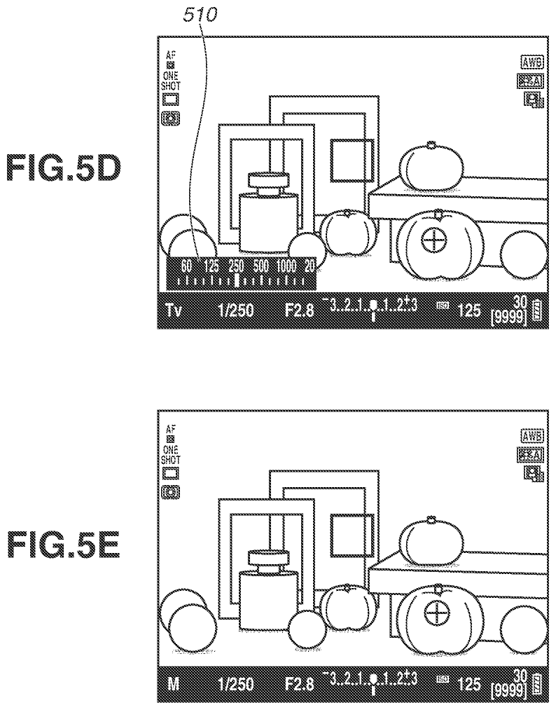

FIGS. 5A to 5E are diagrams each illustrating a screen display displayed on the EVF 29.

In FIGS. 5A to 5E, an AF frame 502 indicates a range for conducting an automatic focusing.

The gaze point pointer 503 indicates the user's gaze point detected by the eye tracking unit 110, and is formed by a +mark (a cross mark) and a circle surrounding the cross mark in the illustrated example.

GUIs 504, 505, 506, 507, and 508 each display a parameter regarding the imaging. The GUIs 504, 505, 506, 507, and 508 indicate values of the imaging mode setting, the International Organization for Standardization (ISO) sensitivity setting, the shutter speed setting, the white balance setting, and the exposure correction setting, respectively.

FIG. 5A illustrates a screen display example of a state where the user directs his/her gaze to the GUI 505 for the ISO sensitivity setting, and the gaze point pointer 503 is translucently displayed on the position of the GUI 505 for the ISO sensitivity setting. In a case where the user rotates the main electronic dial 71 in this state, the screen transitions to a screen including a GUI 509 for changing the ISO sensitivity value like the example illustrated in FIG. 5B, and the ISO sensitivity value is changed according to the rotation amount.

FIG. 5C illustrates a screen display example in a state where the user directs his/her gaze to a live view image (an LV image) that is not the GUIs displaying the parameters regarding imaging, and the gaze point pointer 503 is translucently displayed on the position of the live view image (the LV image). In this case, the still image capturing mode is set to the shutter speed priority mode (the Tv mode). In a case where the user rotates the main electronic dial 71 in this state, the screen transitions to a screen including a GUI 510 for changing the shutter speed like the example illustrated in FIG. 5D, and the shutter speed is changed according to the rotation amount.

FIG. 5E illustrates a screen display example in a state where the user directs his/her gaze to a live view image (an LV image) that is not the GUIs displaying the parameters regarding imaging, and the gaze point pointer 503 is translucently displayed on the position of the live view image (the LV image). In this case, the still image capturing mode is set to the manual imaging mode (the M mode). In a case where the user rotates the main electronic dial 71 at in this state, the setting value regarding the function assigned with the main electronic dial 71 as the priority operation member on the function registration screen illustrated in FIG. 4B is changed.

The digital camera 100 is configured to, in a case where the user directs his/her gaze on a GUI, determine that the function corresponding to the GUI is the operation item regarding an operation on an operation member (the main electronic dial 71 in the present exemplary embodiment) according to the user's gaze point in this manner. Accordingly, the digital camera 100 allows the user to operate a plurality of operation items by using one operation member (for example, the main electronic dial 71). In a case where the user does not direct his/her gaze to any GUI, the user can operate the function prioritized for the operation member in each imaging mode. More specifically, the user can change the Av value (the aperture value) in the Av priority mode (the aperture priority mode) with an operation on the one operation member (the main electronic dial 71 in the present exemplary embodiment). The user can change each of the Tv value (the shutter speed) in the Tv priority mode (the shutter speed priority mode) and the setting value regarding the preassigned function in another imaging mode by operating the one operation member (the main electronic dial 71 in the present exemplary embodiment). It is apparent that the function prioritized in the Av priority mode (the aperture priority mode) is the Av value (the aperture value), and the function prioritized in the Tv priority mode (the shutter speed priority mode) is the Tv value (the shutter speed) for users of cameras settable to these imaging modes. Thus, the present configuration can eliminate a risk of a setting change unintended for the user (contrary to the user's intention) by an operation on the one operation member (for example, the main electronic dial 71), whereby an intuitive and easily understandable operation can be realized.

In a case where a rotational member or a touch member is employed as the one operation member, the user can operate the operation member in any of a direction for increasing the setting value and a direction for reducing the setting value by relying only on sense of the touch without visually checking the operation member, and thus the present configuration is further effective in operating a plurality of operation items.

The gaze point pointer 503 is formed by a point (a dot) or a +mark (a cross mark) and a circle surrounding the point or the cross mark and is translucently displayed, whereby the user can easily recognize which GUI is identified as a user's gaze target on the electronic apparatus according to the exemplary embodiment of the present invention. Thus, the user can further conveniently perform a function selection with his/her gaze.

The gaze point pointer 503 can also be displayed with a higher degree of transparency or can be hidden in a case where the gaze point pointer 503 overlaps the GUI. In a case where the display of the gaze point pointer 503 is controlled in this manner, which of the GUIs is recognized as the user's gaze target can become further recognizable.

The present exemplary embodiment uses an input performed at a display position based on the user's gaze to determine an operation target item of the operation member. Alternatively, the configuration of the present exemplary embodiment can also serve another purpose in addition thereto. For example, the configuration of the present exemplary embodiment can be also employed for setting a region in which automatic focusing is conducted (a so-called “AF frame”).

In the present exemplary embodiment, the parameters for the imaging are not changed by the input based on the user's gaze alone, and the operation member, such as the rotational member and the touch member, is operated to change the parameters. Consequently, according to the present exemplary embodiment, the risk of a setting change unintended for the user (contrary to the user's intention) can be reduced.

The present invention can also be applied to an apparatus different from the imaging apparatus. For example, the present invention may be applied to a computer (a personal computer (PC), and an exemplary embodiment in this case may be configured in such a manner that a target of a scroll wheel operation of a mouse is determined according to a gaze point on the display (in a case where a user views a region that is not a GUI, a preassigned operation is performed).

A second exemplary embodiment is an example in which the present invention is applied to a case where a display item as a digital graphic is displayed on a head mount-type display in a superimposed manner on a live view (LV) as if the display item is present in the live view, and this example will be described next. This is a so-called Mixed Reality Head Mounted Display (MRHMD).

There has been emerged a technique called Internet of Things (hereinafter referred to as “IoT”) designed to make it possible to recognize electric appliances, locate the positions thereof, specify the addresses thereof, and control them via a network (the Internet, an ad-hoc system, or the like). Examples of the electric appliances include daily “things”, such as a television (TV) system, lighting equipment, an air conditioner, a music system, a door of a room or a garage, a home security system, a fan, a sprinkler system, a microwave, an oven, a dish washer, a clothes washer, and a dryer.

Web Services Dynamic Discovery (WS-Discovery), multicast Domain Name Service (mDNS), and the like have been known as service detection protocols for searching for a service in a local network or a nearby device.

Under these circumstances, in the present exemplary embodiment, image recognition processing is performed on a live view image, and which of apparatus functions is targeted for a setting value change or control is determined based on an input of a user's gaze with respect to a subject currently displayed in the live view image, to allow the user to perform operations using one operation member. As a result, a simple and intuitively understandable operation can be realized.

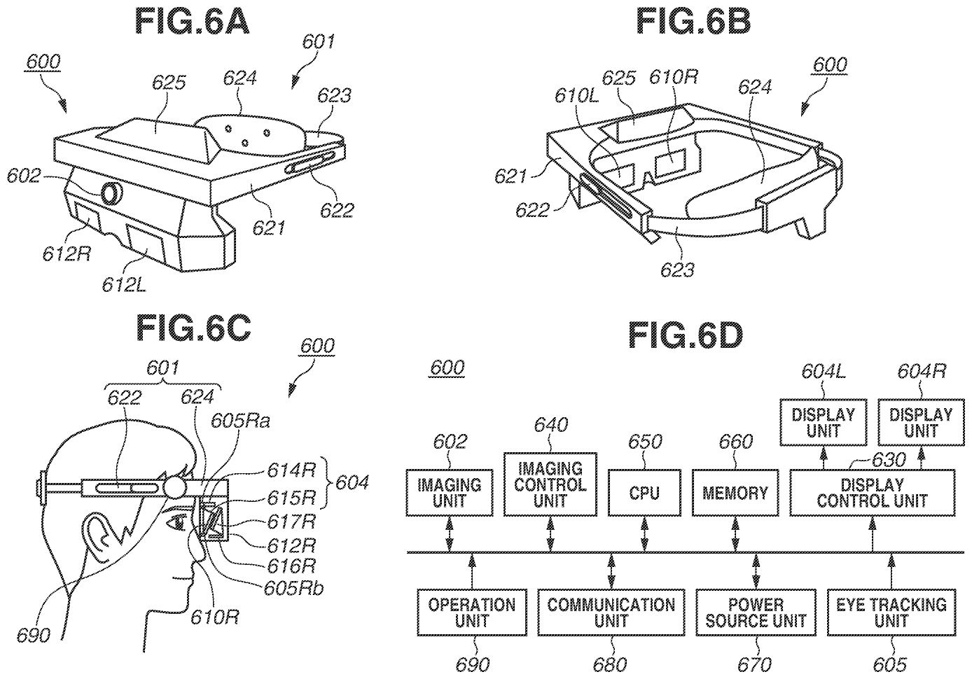

FIG. 6A illustrates the external appearance of an MRHMD 600 according to the present exemplary embodiment of the present invention as viewed from the front side. FIG. 6B illustrates the external appearance as viewed from the back side, and FIG. 6C illustrates a side view with the MRHMD 600 mounted on the head portion of the user. FIG. 6D is a block diagram schematically illustrating a configuration of the MRHMD 600.

A head-portion mount unit 601 is designed to mount the MRHMD 600 on the head portion of the user, and includes members 621 to 625. To mount the MRHMD 600 onto the head portion, first, the MRHMD 600 is placed on the head with a length adjustment unit 623 loosened using an adjuster 622. Then, the length adjustment unit 623 is tightened using the adjuster 622 to bring a side head mount portion 621 and a back head mount portion 624 into close contact with the side-head portion and the back-head portion, respectively, after a forehead mount portion 625 is brought into close contact with the forehead. Various types of the MRHMD 600, such as an eyeglass frame type and a helmet type, are available besides the goggle type described herein.

An imaging unit 602 is a so-called digital camera, and is disposed on the MRHMD 600 to image substantially the same direction as the direction in which the face of the user wearing the MRHMD 600 on his/her head portion is directed. More specifically, the imaging unit 602 guides light incident from outside the MRHMD 600 via incident windows 612L and 612R, collectively called as an incident window 612, into the MRHMD 600 via optical prisms 617L (not illustrated) and 617R, collectively called as an optical prism 617, and receives the light by image sensors 616L (not illustrated) and 616R, collectively called as an image sensor 616.

A display unit 604 (including display units 604L and 604R) include a screen 610 (including screens 610L and 610R), a color liquid crystal display 614 (including color liquid crystal displays 614L (not illustrated) and 614R), and an optical prism 615 (including optical prisms 615L (not illustrated) and 615R), respectively. The alphabets L and R added to the reference numerals indicate a component for the left eye and a component for the right eye, respectively. The display unit 604 is disposed at a position corresponding to a position of lenses of eyeglasses, to face the position of the eyes of the user. An image to be displayed on the color liquid crystal display 614 is guided to the screen 610 using the optical prism 615 and is displayed on the screen 610.

The MRHMD 600 is configured in such a manner that an output light of the optical prism 615 of the display unit 604 and an input light of the optical prism 617 of the imaging unit 602 match an optical axis of the user's pupil.

The image sensor 616 images a subject in the real space visually recognizable from the user's position and direction.

Eye tracking units 605La and 605Lb, and 605Ra and 605Rb, collectively called as an eye tracking unit 605, are disposed above and below the display units 604L and 604R, respectively. When the user looks into the display unit 604, the user's gaze is detected by the eye tracking unit 605, and which portion on the screen 610 the user is viewing is determined.

The color liquid crystal display 614 displays an image in which a predetermined display item is superimposed (combined) on the image in the real space that is captured by the imaging unit 602 (the live view).

As illustrated in FIG. 6D, the MRHMD 600 includes a display control unit 630, an imaging control unit 640, a central processing unit (CPU) 650, a memory 660, a power source unit 670, a communication unit 680, and an operation unit 690 inside a main body of the MRHMD 600 (including the head-portion mount unit 601).

The display control unit 630 controls a display on the display unit 604. More specifically, the display control unit 630 controls, for example, the size, the position, the orientation, the color, and the transparency of a display item that is displayed (combined) on the real-space image (the live view), and a movement and a change in brightness of the display item according to a change in the real-space image (the live view).

The imaging control unit 640 controls an exposure, ranging, and the like, based on a calculation result of predetermined calculation processing using a captured image. Due to this control, AF (automatic focus) processing, AE (automatic exposure) processing, AWB (automatic white balance) processing, and the like are performed. In a case where the imaging unit 602 includes a mechanism for inserting/retracting an optical filter into/from the optical path, an image stabilization mechanism, and the like, the imaging control unit 640 performs the insertion/retraction of the optical filter and an image stabilization operation according to the operation situation.

The CPU 650 generally controls the MRHMD 600 and performs various kinds of calculation processing. The CPU 650 realizes control and processing that will be described below by executing a program stored in the memory 660.

The memory 660 includes a work area and a nonvolatile area. A program read out from the nonvolatile area, and a constant and a variable for system control are developed into the work area. Data of an image of a virtual object to be displayed on the real space image is stored in the memory 660 for the display. Further, image data captured by the imaging unit 602 and subjected to an A/D conversion is developed into the memory 660 for the purpose of an image analysis, image processing, and/or the like.

The power source unit 670 includes a primary battery, such as an alkaline battery or a lithium battery, and a secondary battery, such as an NiCd battery, an NiMH battery, or an Li battery, an AC adapter, or the like, and supplies power to the MRHMD 600. The power source unit 670 includes a power switch that switches a power-on and a power-off according to a user operation or another condition.

The communication unit 680 exchanges data with another apparatus, a server, or the like via the Internet, a local area network (LAN), Bluetooth®, Wireless Fidelity (Wi-Fi) Direct, or the like based on the control by the CPU 650.

The operation unit 690 is an input unit that receives an operation from the user (a user operation), and is used to input various kinds of operation instructions to the CPU 650. The operation unit 690 is, for example, an electronic dial, a touch bar, or the like. The operation unit 690 may be provided as another device, such as a remote controller.

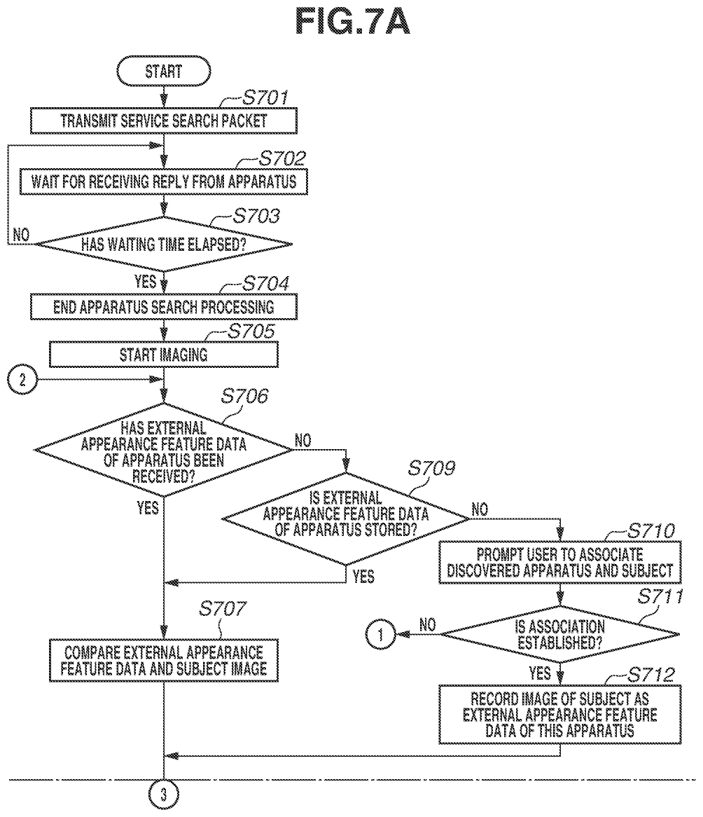

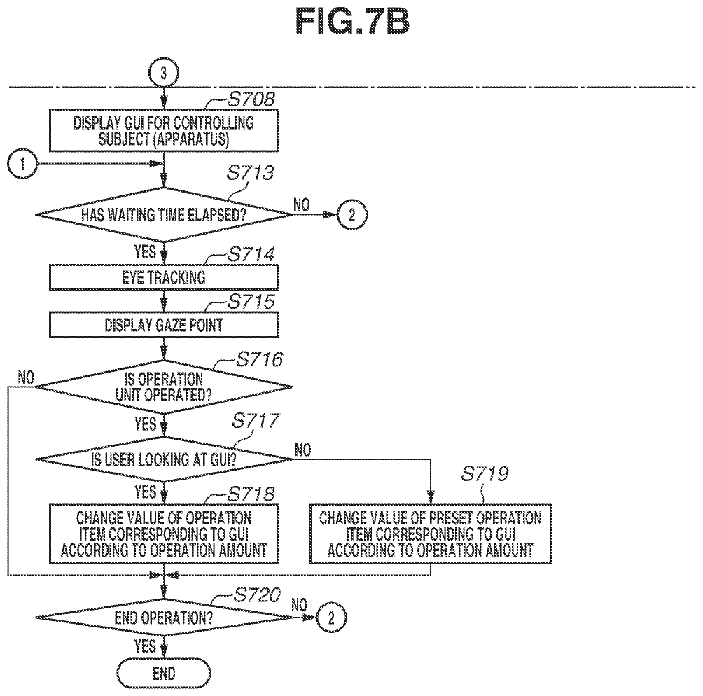

FIGS. 7A and 7B are flowcharts illustrating a processing procedure of a determination and processing in which the electronic apparatus according to the present exemplary embodiment of the present invention controls a function of an IoT apparatus in correspondence with an input of the user's gaze and an operation on the operation member.

In step S701, when being powered on by the user, the electronic apparatus according to the exemplary embodiment of the present invention transmits a service search packet according to a service search protocol.

In step S702, the electronic apparatus waits for receiving a reply (a response) to the search packet transmitted in step S701 from an apparatus. Subsequently, in step S703, the electronic apparatus determines whether a predetermined waiting time has elapsed. In a case where the predetermined waiting time has elapsed (YES in step S703), the processing proceeds to step S704. In step S704, the electronic apparatus ends the apparatus search processing. Then, in step S705, the electronic apparatus starts imaging by the imaging unit 602. Then, in step S706, the electronic apparatus determines for each discovered apparatus whether external appearance feature data of the apparatus has been received. In a case where the external appearance feature data has been received (YES in step S706), the processing proceeds to step S707. In step S707, the electronic apparatus compares the received data and an image of the subject in the live view. Then, in step S708, the electronic apparatus displays a GUI for controlling the subject (the apparatus) near the subject (the apparatus) that matches the external appearance feature data. In a case where the external appearance feature data has not been received (NO in step S706), the processing proceeds to step S709. In step S709, the electronic apparatus determines whether the external appearance feature data of the apparatus is stored in the memory 660. Then, in a case where the external appearance feature data is stored in the memory 660 (YES in step S709), the processing proceeds to step S707. In step S707, the electronic apparatus compares the stored external appearance feature data and the image of the subject in the live view. In step S708, the electronic apparatus displays a GUI for controlling the subject (the apparatus) near the subject (the apparatus) that matches the external appearance feature data. In a case where the external appearance feature data is not stored (NO in step S709), processing proceed to step S710. In step S710, the electronic apparatus displays a message prompting the user to associate the discovered apparatus and a subject in the live view. In a case where the association is established by the user (YES in step S711), the processing proceeds to step S712. In step S712, the electronic apparatus records and stores the image of the subject into the memory 660 as external appearance feature data of the apparatus.

Then, in step S713, the electronic apparatus determines whether the predetermined waiting time has elapsed. In a case where the waiting time has elapsed (YES in step S713), the processing proceeds to step S714. In step S714, the electronic apparatus detects a user's gaze point by the eye tracking unit 605. In step S715, the electronic apparatus displays a “gaze point indicator” at the user's gaze point on the display unit 604.

Then, in step S716, the electronic apparatus determines whether the operation unit 690 is operated by the user. In a case where the electronic apparatus determines that the operation unit 690 is operated (YES in step S716) the processing proceeds to step S717. In step S717, the electronic apparatus further determines whether a GUI of an apparatus function is displayed at the user's gaze point. In a case where the electronic apparatus determines that the user is viewing the predetermined display item (YES in step S717), the processing proceeds to step S718. In step S718, the electronic apparatus changes a value of an operation item corresponding to the GUI (for example, the temperature setting of the air conditioner in a case where the electronic apparatus determines that the user is viewing a temperature GUI of the air conditioner) according to the operation amount.

On the other hand, in a case where the electronic apparatus determines that the user is not viewing a GUI of an apparatus function (NO in step S717), the processing proceeds to step S719. In step S719, the electronic apparatus changes a value of a function setting preset to the operation unit 690, such as brightness of the lighting, according to the operation amount.

In a case where electronic apparatus determines that the operation unit 690 is not operated by the user in step S716 (NO in step S716), the processing proceeds to step S720. In step S720, the electronic apparatus further determines whether an end operation, such as turning off the electronic apparatus, is performed by the user. Then, in a case where the end operation is performed by the user (YES in step S720), the processing procedure of the flowchart is ended. On the other hand, in a case where no end operation is performed by the user (NO in step S720), the processing returns to the state immediately after the start of the imaging (step S706).

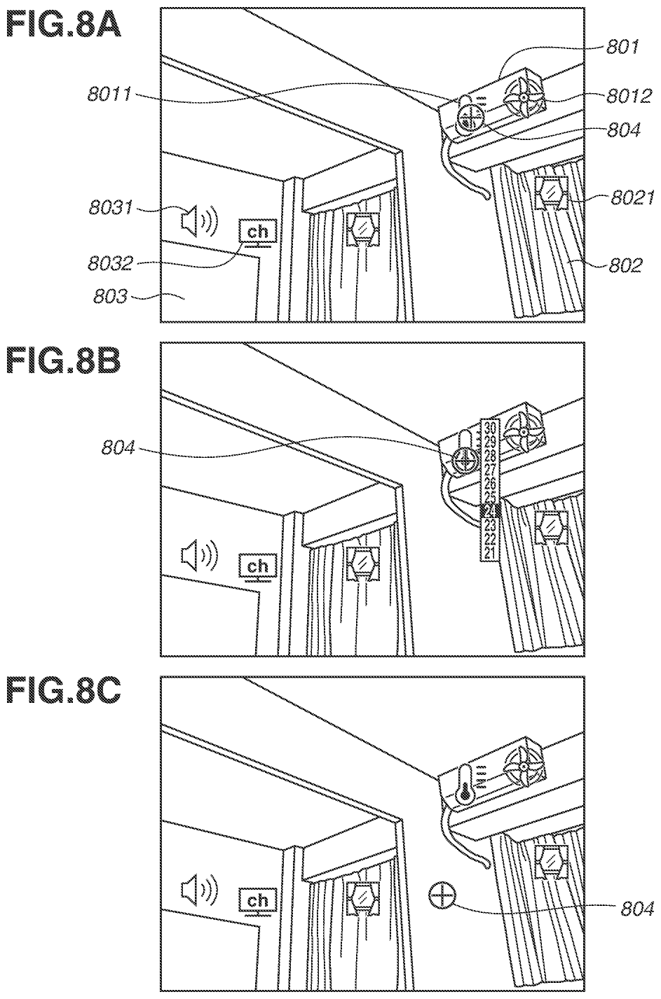

FIGS. 8A to 8C are screen transition diagrams illustrating a transition of the screen displayed on the display unit 604 of the electronic apparatus according to the present exemplary embodiment of the present invention.

In FIGS. 8A to 8C, an air conditioner 801, a curtain 802, and a TV system 803 are the subjects in a live view.

A temperature GUI 8011 and a fan power GUI 8012 are displayed near the air conditioner 801, an opening/closing GUI 8021 is displayed near the curtain 802, and a volume GUI 8031 and a channel GUI 8032 are displayed near the TV system 803.

FIG. 8A illustrates a display example in a state where the user directs his/her gaze to the temperature GUI 8011, and a gaze point indicator 804 is translucently displayed on a position of the temperature GUI 8011. In a case where the user operates the operation unit 690 in this state, the screen transitions to a screen including a GUI for changing the temperature of the air conditioner 801 like the example illustrated in FIG. 8B, and the temperature setting of the air conditioner 801 is changed according to the operation amount.

FIG. 8C illustrates a screen display example in a state where the user directs his/her gaze to a live view image (an LV image) where the GUIs are not displayed, and the gaze point indicator 804 is displayed at a position of the live view image (the LV image). In this state, in a case where, for example, brightness of the lighting is preset as the prioritized operation item of the operation unit 690, brightness of the lighting is changed according to the operation amount by which the operation unit 690 is operated by the user.

In the above-described manner, with the electronic apparatus according to the present exemplary embodiment (the MRHMD 600), a plurality of apparatus functions controllable via a network can be operated using one operation member, whereby convenience is improved. Further, the present configuration can eliminate a risk of a setting change unintended for the user (contrary to the user's intention), and the user can intuitively and easily operates the electronic apparatus.

The user wearing the MRHMD 600 on his/her head portion cannot directly visually check the operation unit 690, but can perform an operation in any of the direction for increasing a setting value and the direction for reducing the setting value by relying on the sense of touch in a case where the rotational member or the touch member is served as the operation unit 690. Accordingly, the present configuration is further effectively usable to operate a plurality of operation items.

The control by the CPU according to the exemplary embodiments of the present invention may be performed by a single hardware apparatus, or may be performed in such a manner that a hardware resource as a different apparatus is in charge of the calculation processing as so-called cloud computing and the electronic apparatus is controlled according to a result of the calculation processing.

Having described the representative exemplary embodiments of the present invention, the present invention is not limited to the above-described specific exemplary embodiments, and also includes various embodiments within a range that does not depart from the spirit of the invention. Each of the above-described exemplary embodiments merely indicates an exemplary embodiment of the present invention, and each of the exemplary embodiments can also be combined with another embodiment as appropriate.

The present invention can also be realized by performing the following processing. That is, the present invention can also be realized by processing that supplies a software program capable of fulfilling the functions of the above-described exemplary embodiments to a system or an apparatus via a network or various kinds of recording media, and causes a computer (or a CPU, a micro processing unit (MPU), or the like) of the system or the apparatus to read out and execute a program code. In this case, the program, and the recording medium storing the program constitute the present invention.

According to the present invention, the electronic apparatus capable of receiving an operation based on user's eye tracking is configured to prevent, in a case where a user does not direct his/her gaze to a predetermined display item, an operation item other than an operation item preassigned to an operation member from being operated by a user operation performed on the operation member. With this configuration, the electronic apparatus can achieve an advantageous effect of preventing an operation item unintended by the user from being operated, and consequently the user friendliness is improved.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-036294, filed Mar. 8, 2021, which is hereby incorporated by reference herein in its entirety.

What is claimed is:

1. An electronic apparatus comprising:
an operation member configured to receive an operation performed by a user;
a display device configured to display a display item; and
at least one memory and at least one processor which function as:
an eye tracking unit configured to detect a gaze point of the user on the display device, and
an execution unit configured to perform control to execute a first processing corresponding to a first operation item assigned to the operation member or a second processing corresponding to a second operation item assigned to the display item displayed at the detected gaze point, in response to an operation to the operation member performed by a user,
wherein, in a case where the display item is not displayed at the detected gaze point, the execution unit performs control to execute the first processing, and in a case where the display item is displayed at the detected gaze point, the execution unit performs control to execute the second processing.

2. The electronic apparatus according to claim 1,
wherein the operation member is a rotational member, and
wherein in the first processing, a setting value corresponding the first operation item assigned to the operation is changed according to a rotation amount of the operation member.

3. The electronic apparatus according to claim 1, wherein the operation member receives a touch operation performed by the user, and
wherein in the first processing, a setting value corresponding the first operation item is changed according to a movement amount of the touch operation performed on the operation member.

4. The electronic apparatus according to claim 1, the second operation item is an operation item assigned to the display item displayed at the detected gaze point among a plurality of display items displayed on the display device.

5. The electronic apparatus according to claim 1, the first operation item is an operation item assigned to the operation member by a user operation from among a plurality of operation items each corresponding to different one of a plurality of display items displayed on the display device.

6. The electronic apparatus according to claim 1, further comprising:
an imaging device; and
an imaging mode setting unit configured to set an imaging mode to any of a plurality of imaging modes including a shutter speed priority mode and an aperture priority mode,
wherein the first operation item is an adjustment of a shutter speed in the shutter speed priority mode and an adjustment of an aperture value in the aperture priority mode.

7. The electronic apparatus according to claim 1, wherein an object indicating the gaze point detected by the eye tracking unit is displayed on the display device.

8. The electronic apparatus according to claim 7, wherein, in a case where the object is displayed on the display item, the object is displayed with a higher degree of transparency than a degree of when the object is displayed not on the display item, or is not displayed.

9. The electronic apparatus according to claim 1, further comprising:
an imaging device,
wherein the at least one memory and the at least one processor further function as:
a connection unit configured to connect to an external apparatus via a network,
a display control unit configured to perform control to display a live view image captured by the imaging device on the display device, and
a recognition unit configured to perform image recognition processing on the live view image and recognize the external apparatus that the electronic apparatus can control,
wherein an operation item for controlling the recognized external apparatus is assigned to the display item, and the display item is displayed on the display device together with the live view image.

10. A method for controlling an electronic apparatus, the electronic apparatus including an operation member configured to receive an operation performed by a user, a display device configured to display a display item, and an eye tracking unit configured to detect a gaze point of the user on the display device, the method comprising:
performing, in a case where the display item is not displayed at the detected gaze point, control to execute a first processing corresponding to a first operation item assigned to the operation member, in response to an operation to the operation member performed by a user; and
performing, in a case where the display item is displayed at the detected gaze point, control to execute a second processing corresponding to a second operation item assigned to a display item displayed at the detected gaze point.

11. A computer-readable non-transitory recording medium storing a program for causing a computer to function as each process in the method for controlling the electronic apparatus according to claim 10.
